(19) United States
(12) Patent Application Publication
(10) Pub. No.: US 2020/0200283 A1
(43) Pub. Date: Jun. 25, 2020

(54) VALVE DEVICE

(71) Applicant: LIXIL Corporation, Tokyo (JP)

(72) Inventors: Kengo FUJII, Tokyo (JP); Atsushi KUSHIMOTO, Tokyo (JP); Yousuke TAJIMA, Tokyo (JP)

(73) Assignee: LIXIL Corporation, Tokyo (JP)

(21) Appl. No.: 16/642,841

(22) PCT Filed: Aug. 6, 2018
(86) PCT No.: PCT/JP2018/029451

§ 371 Date: Feb. 27, 2020

(30) Foreign Application Priority Data
Aug. 30, 2017 (JP) 2017-165829

(51) Int. Cl. F16K 11/074

(52) U.S. Cl. CPC F16K 11/074

(57) ABSTRACT

Provided are valve devices that can be formed compactly. A valve device includes a primary-side valve element including a planar part and a secondary-side valve element connected to the primary-side valve element to be slidable to the planar part of the primary-side valve element, in which a water discharge state can be switched by sliding the primary-side valve element or the secondary-side valve element. The secondary-side valve element includes a packing member that contacts the planar part of the primary-side valve element. The primary-side valve element can include a disk member including the planar part, and the disk member is made from metal.

### CROSS-REFERENCE TO RELATED APPLICATIONS

This application is a national stage application under 35 USC 371 of International Application No. PCT/JP2018/029451, filed Aug. 6, 2018, which claims the priority of Japanese Application No. 2017-165829, filed Aug. 30, 2017, the entire contents of each of which are incorporated herein by reference.

### FIELD OF THE DISCLOSURE

The present invention relates to a valve device including a primary-side valve element and a secondary-side valve element connected to the primary-side valve element.

### BACKGROUND OF THE DISCLOSURE

Cylinder type valve devices including a tubular cylinder valve element including a valve element-side opening, a tubular valve case disposed outside the cylinder valve element, and a case-side opening have conventionally been known (for example, see Patent Document 1). In the cylinder type valve device disclosed in Patent Document 1, water can flow in a state in which the valve element-side opening formed on a peripheral face of the cylinder valve element is overlapped with the case-side opening formed on a peripheral face of the valve case by rotation of the cylinder valve element, and the flow of water can be stopped in a state in which the valve element-side opening is not overlapped with the case-side opening.

Patent Document 1: Japanese Patent No. 5732661

### SUMMARY OF THE DISCLOSURE

The cylinder valve device of Patent Document 1 is configured to switch between water flow and water stop by rotation of the tubular cylinder valve element, and requires a cylinder valve element extending in a tubular shape; thus, the length in the length direction of the valve device is apt to be long. Therefore, a valve device formed compactly is desired.

Provided are valve devices that can be formed compactly.

Embodiments of the present invention relate to a valve device (e.g., the disk type valve device 6 described later), including: a primary-side valve element (e.g., the primary-side valve element 7 described later) including a planar part (e.g., the sliding plane 751b described later); and a secondary-side valve element (e.g., the secondary-side valve element 8 described later) connected to the primary-side valve element to be slidable to the planar part of the primary-side valve element, wherein a water discharge state can be switched by sliding the primary-side valve element or the secondary-side valve element, and the secondary-side valve element includes a packing member (e.g., the packing member 85 described later) that contacts the planar part of the primary-side valve element.

In some embodiments, the primary-side valve element includes a disk member (e.g., the disk member 75 described later) including the planar part, and the disk member is made from metal.

In some embodiments, the primary-side valve element includes a disk member including the planar part and a shaft member (e.g., the valve shaft part 72 described later) supporting the disk member, and water can flow between the disk member and the shaft member.

In some embodiments, the primary-side valve element is a movable valve that can be rotated at a time of operation.

In some embodiments, the primary-side valve element includes a disk member including a primary-side opening (e.g., the disk opening 752 described later), and an outer peripheral edge (e.g., the outer side 752d described later) of the primary-side opening is not formed along a circular shape (e.g., the outer peripheral edge 751c described later) centered on a rotation axis of the disk member.

In some embodiments, the primary-side valve element includes a primary-side tubular member (e.g., the primary-side cylindrical member 71 described later) and a disk member including the planar part, and the disk member is movable toward the secondary-side valve element with respect to the primary-side tubular member by water pressure applied to the primary-side valve element.

In some embodiments, a gap is formed between the disk member and the packing member by applying strong water pressure and subsequently applying weak water pressure to the primary-side valve element.

According to the present invention, it is possible to provide a valve device that can be formed compactly.

### BRIEF DESCRIPTION OF THE FIGURES

FIG. 1 is a perspective view of a faucet apparatus including a disk type valve device, according to some embodiments;

FIG. 2 is a cross-sectional view taken along line A-A in FIG. 1, and is a vertical cross-sectional view showing a main configuration of the disk type valve device, according to some embodiments;

FIG. 3 is a perspective view of the disk type valve device, according to some embodiments;

FIG. 4 is a cross-sectional view taken along line B-B in FIG. 3, according to some embodiments;

FIG. 5 is a cross-sectional view taken along line C-C in FIG. 3, according to some embodiments;

FIG. 6 is a perspective view showing a state in which the disk type valve device is separated into a primary-side valve element and a secondary-side valve element, according to some embodiments;

FIG. 7 is a perspective view of the primary-side valve element of the disk type valve device as viewed from the side of a disk member, according to some embodiments;

FIG. 8 is an exploded perspective view of the primary-side valve element of the disk type valve device, according to some embodiments;

FIG. 9A is a plan view of the disk member of the primary-side valve element, according to some embodiments;

FIG. 9B is a plan view of the secondary-side valve element disposed facing the disk member of the primary-side valve element, according to some embodiments;

FIG. 10A shows an overlapping state of a disk opening of the disk member of the primary-side valve element, according to some embodiments;

FIG. 10B shows a shower-side opening, according to some embodiments;

FIG. 10C shows a faucet-side opening of the secondary-side valve element in a rotation position of the primary-side valve element, according to some embodiments; and

FIG. 11 shows how a gap is formed between the disk member and a packing member by applying strong water pressure and subsequently applying weak water pressure to the primary-side valve element, according to some embodiments.

### DETAILED DESCRIPTION OF THE DISCLOSURE

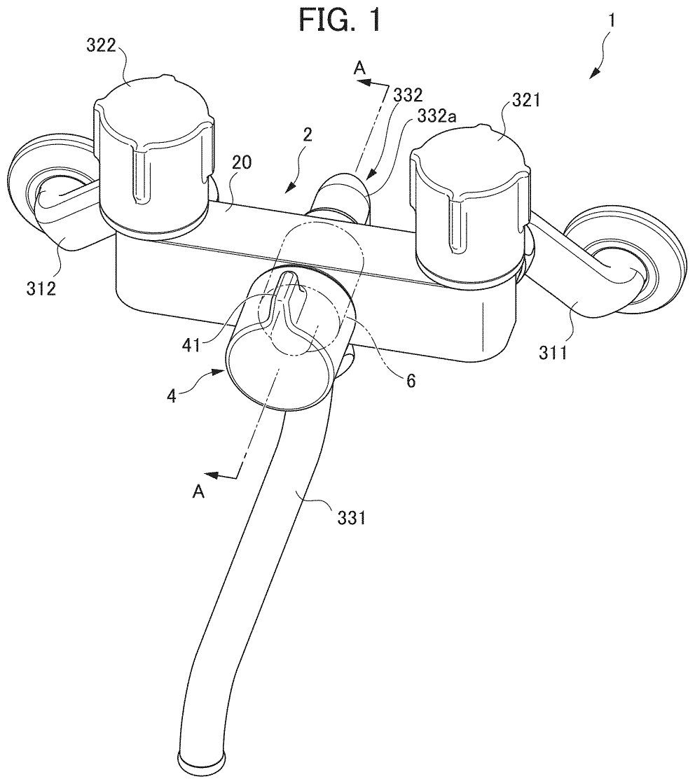

Hereinafter, a faucet apparatus 1 according to embodiments of the present invention will be explained while referencing the drawings. FIG. 1 is a perspective view of the faucet apparatus 1 including a disk type valve device 6 according to some embodiments of the present invention. In some embodiments, when the faucet apparatus 1 is viewed from the front face, a near side on which a faucet-side water discharging part 331 is disposed is referred to as the front side (front face side), and a far side on which a shower-side water discharging part 332 is disposed is referred to as the rear side (back face side). When the faucet apparatus 1 is viewed from the front face, the right and left directions are referred to as a right-and-left direction.

As shown in FIG. 1, the faucet apparatus 1 includes a faucet body 2, a cold water-side crank leg 311, a hot water-side crank leg 312, a cold water-side handle 321, a hot water-side handle 322, the faucet-side water discharging part 331, the shower-side water discharging part 332, a switching handle 4, and a disk type valve device 6 (valve device).

In some embodiments, the faucet apparatus 1 is a wall-mounted type mixing faucet including two handles (the cold water-side handle 321 and the hot water-side handle 322). The faucet apparatus 1 switches a water discharge state by adjusting the mixing ratio of cold water and hot water supplied from the cold water-side crank leg 311 and the hot water-side crank leg 312 with the two handles (the cold water-side handle 321 and the hot water-side handle 322) and rotating the switching handle 4. Specifically, the faucet apparatus 1 switches between the water stop state and the water flow state by rotation of the switching handle 4, and adjusts the flow rate of water discharged from each of the water discharging parts (the faucet-side water discharging part 331 and the shower-side water discharging part 332).

The faucet body 2 extends in a right-and-left direction. The faucet body 2 is constituted by a box-shaped housing 20 extending in a right-and-left direction, and hot and cold water introduced through the cold water-side crank leg 311 and the hot water-side crank leg 312 and mixed hot and cold water are circulated inside the housing 20. In addition, the disk type valve device 6 (described later) is disposed inside the housing 20.

The cold water-side crank leg 311 and the hot water-side crank leg 312 are respectively connected to both longitudinal ends of the back face of the housing 20 of the faucet body 2. In some embodiments, the cold water-side crank leg 311 is connected to the right end when viewed from the front face in FIG. 1, and the hot water-side crank leg 312 is connected to the left end when viewed from the front face in FIG. 1. With respect to the cold water-side crank leg 311 and the hot water-side crank leg 312, one end is connected to the back face of the faucet body 2, and the other end is fixed to a wall of a bathroom or the like.

The cold water-side handle 321 and the hot water-side handle 322 are respectively provided on either longitudinal end of the top face of the housing 20 of the faucet body 2. In some embodiments, the cold water-side handle 321 is connected to the right end when viewed from the front face, and the hot water-side handle 322 is connected to the left end when viewed from the front face. A cold water-side valve element (not shown) is disposed inside the cold water-side handle 321, and a hot water-side valve element (not shown) is disposed inside the hot water-side handle 322. The mixing ratio of hot and cold water is adjusted by rotating the cold water-side handle 321 and the hot water-side handle 322.

The faucet-side water discharging part 331 extends forward from substantially the center in the longitudinal direction of the bottom face of the housing 20 of the faucet body 2. The shower-side water discharging part 332 includes a shower elbow 332a that horizontally extends from substantially the center in the longitudinal direction of the back face of the housing 20 of the faucet body 2 and bends downward. A tube for supplying hot and cold water to a shower part (not shown) is connected to the shower elbow 332a.

The switching handle 4 is disposed on the front side of substantially the center in the longitudinal direction of the front face of the housing 20 of the faucet body 2. The switching handle 4 is rotatably provided with respect to the faucet body 2. The switching handle 4 is connected to the disk type valve device 6 disposed inside the housing 20 of the faucet body 2. A user of the faucet apparatus 1 switches as to whether water is discharged from the faucet-side water discharging part 331 or the shower-side water discharging part 332 by rotating the switching handle 4, and adjusts the flow rate of water discharged from the faucet-side water discharging part 331 and the shower-side water discharging part 332.

The switching handle 4 is formed in a cylindrical shape. The outer peripheral part of the switching handle 4 is provided with a projecting part 41 that projects upward at the time of water stop. In some embodiments, when the projecting part 41 projects upward, it is a water stop state. When the projecting part 41 is rotated to the right viewed from the front face, it is a water discharge state in which hot and cold water is discharged from the faucet-side water discharging part 331. When the projecting part 41 is rotated to the left viewed from the front face, it is a water discharge state in which hot and cold water is discharged from the shower-side water discharging part 332.

As shown in FIG. 1, the disk type valve device 6 is disposed inside the housing 20 of the faucet body 2 substantially in the center in the longitudinal direction of the faucet body 2. By rotating the switching handle 4, a primary-side valve element 7 (described later) of the disk type valve device 6 can be rotated. By rotating the primary-side valve element 7 of the disk type valve device 6, it is possible to switch between the water flow state and the water stop state. In addition, the disk type valve device 6 can adjust the flow rate of water discharged from the faucet-side water discharging part 331 and adjust the flow rate of water discharged from the shower-side water discharging part 332 in the water flow state.

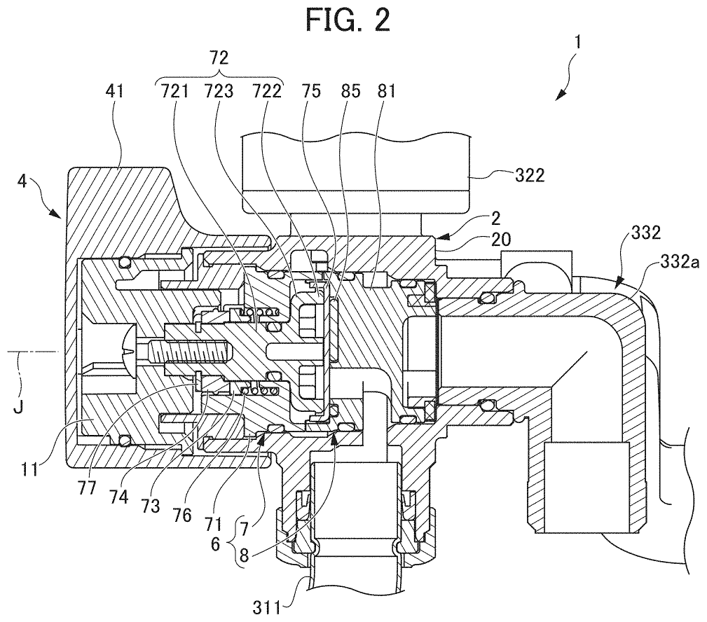

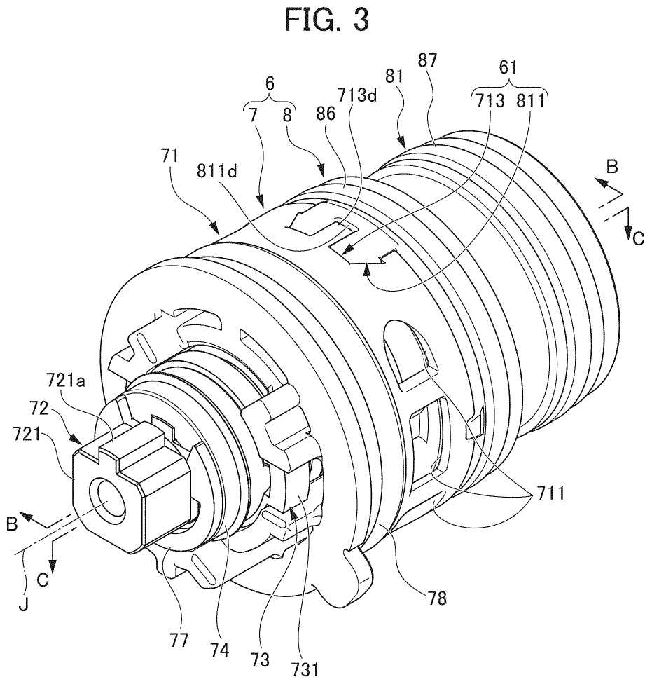

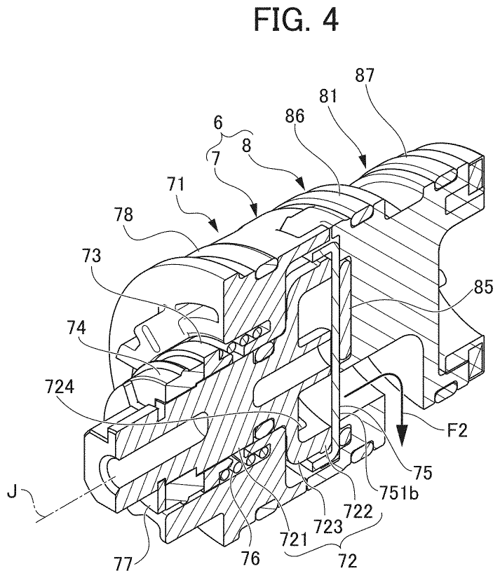

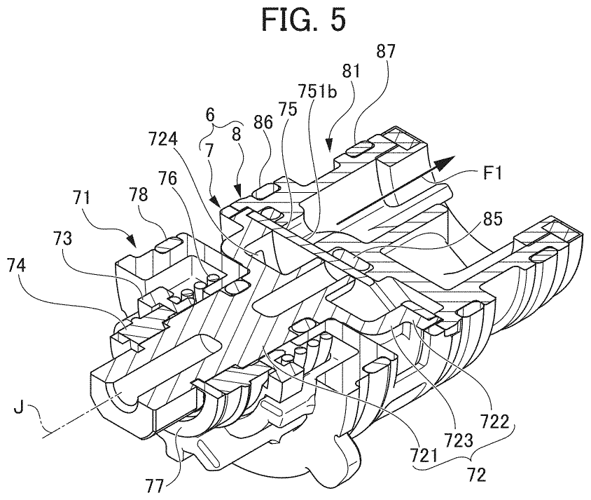

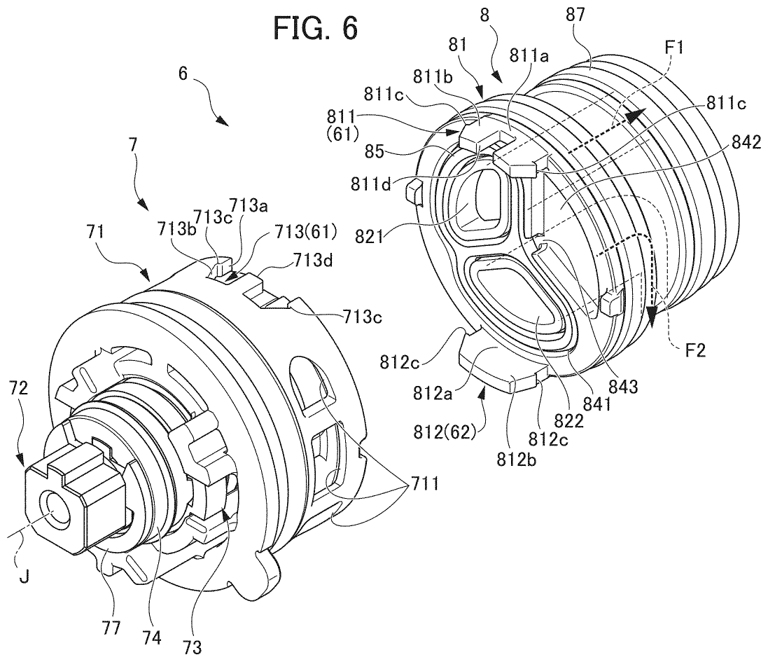

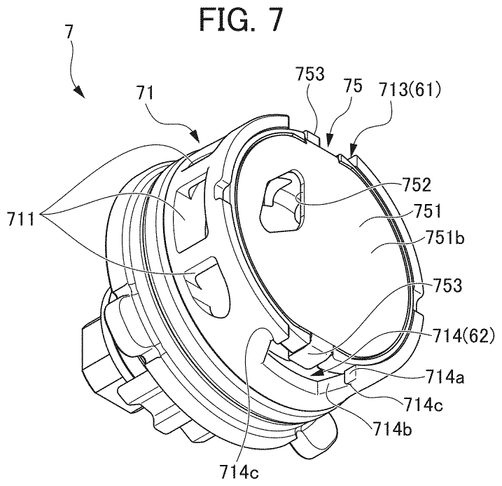

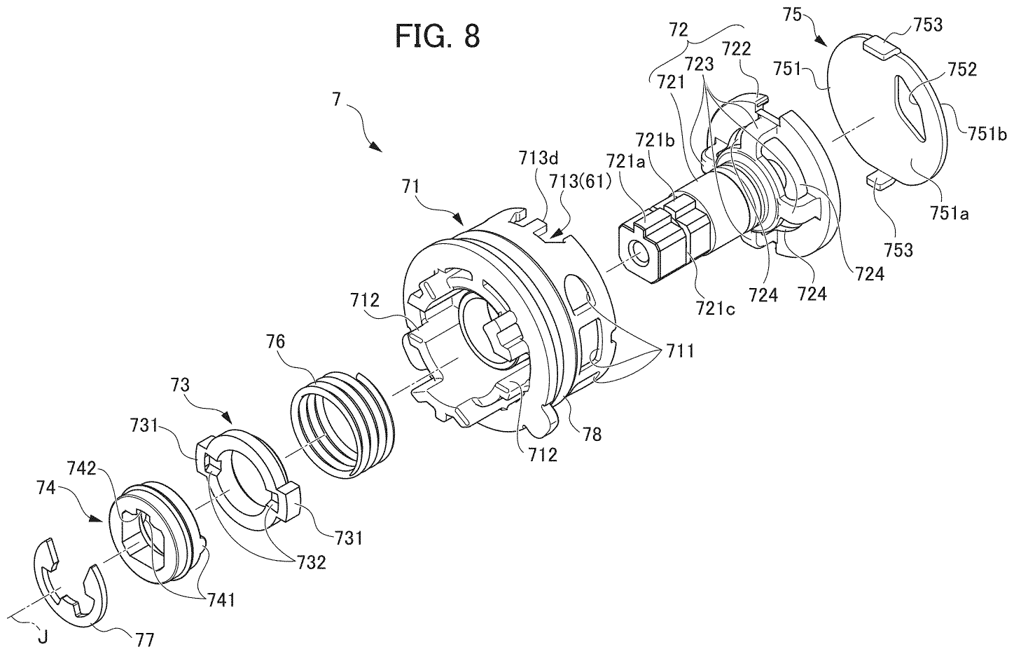

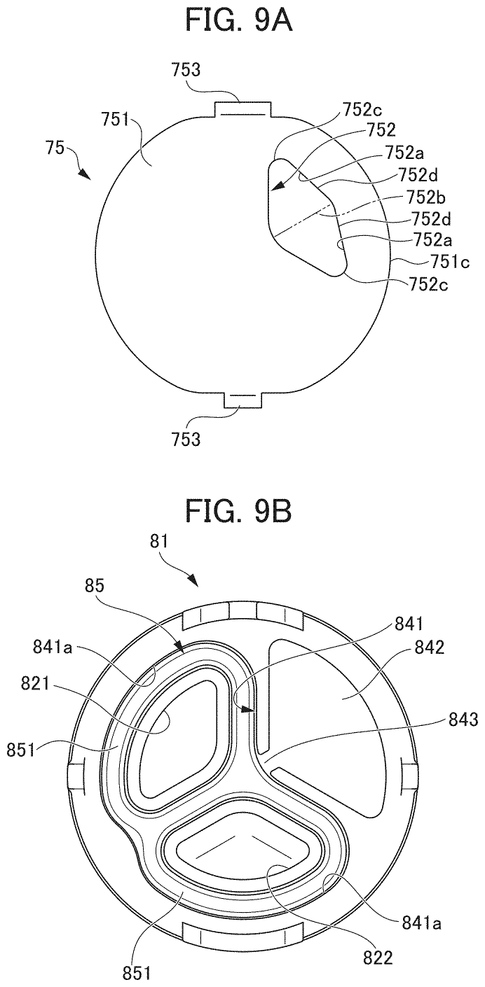

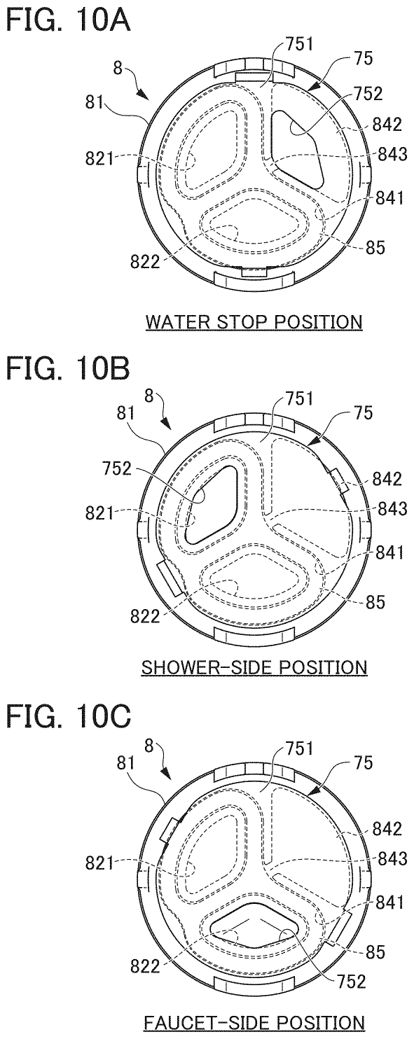

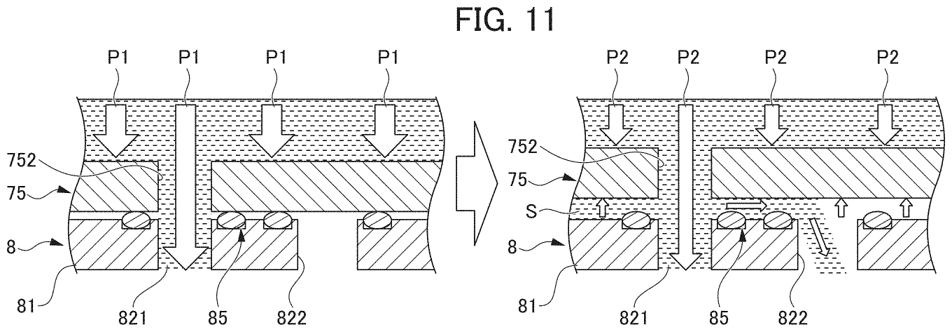

Next, the disk type valve device 6 will be described in detail. FIG. 2 is a cross-sectional view taken along line A-A in FIG. 1, and is a vertical cross-sectional view showing a main configuration of the disk type valve device 6. FIG. 3 is a perspective view of the disk type valve device 6. FIG. 4 is a cross-sectional view taken along line B-B in FIG. 3. FIG. 5 is a cross-sectional view taken along line C-C in FIG. 3. FIG. 6 is a perspective view showing a state in which the disk type valve device 6 is separated into a primary-side valve element 7 and a secondary-side valve element 8. FIG. 7 is a perspective view of the primary-side valve element 7 of the disk type valve device 6 as viewed from the side of a disk member 75. FIG. 8 is an exploded perspective view of the primary-side valve element 7 of the disk type valve device 6. FIG. 9A is a plan view of the disk member 75 of the primary-side valve element 7, and FIG. 9B is a plan view of the secondary-side valve element 8 disposed facing the disk member 75 of the primary-side valve element 7. FIGS. 10A-10C show an overlapping state of a disk opening 752 of the disk member 75 of the primary-side valve element 7 and a shower-side opening 821 or a faucet-side opening 822 of the secondary-side valve element 8 in a rotation position of the primary-side valve element 7. FIG. 11 shows how a gap S is formed between the disk member 75 and a packing member 85 by applying strong water pressure and subsequently applying weak water pressure to the primary-side valve element 7.

As shown in FIG. 1, the disk type valve device 6 is disposed inside the housing 20 of the faucet body 2 substantially in the center in the longitudinal direction of the faucet body 2. As shown in FIG. 2, the switching handle 4 is engaged with an engagement member 11 fixed to the disk type valve device 6. By rotating the switching handle 4, the primary-side valve element 7 of the disk type valve device 6 can be rotated via the engagement member 11.

As shown in FIGS. 3 to 7, the disk type valve device 6 includes the primary-side valve element 7 and the secondary-side valve element 8. As shown in FIG. 6, the primary-side valve element 7 and the secondary-side valve element 8 are respectively formed as a unit. The primary-side valve element 7 is a movable valve that can be rotated when the switching handle 4 is operated. The secondary-side valve element 8 is a fixed valve that is not rotated but fixed. The disk type valve device 6 is installed in the faucet apparatus 1 in a state in which the primary-side valve element 7 and the secondary-side valve element 8 are connected to each other and the peripheral faces of the primary-side valve element 7 and the secondary-side valve element 8 are covered with the housing 20 of the faucet body 2.

The primary-side valve element 7 is connected to the secondary-side valve element 8 so as to be rotatable about a rotation axis J. In some embodiments, the disk type valve device 6 can switch the water discharge state (water flow state or water stop state) by sliding the primary-side valve element 7. In addition, the disk type valve device 6 can adjust the flow rate of water discharged from the faucet-side water discharging part 331 and adjust the flow rate of water discharged from the shower-side water discharging part 332 in the water flow state.

As shown in FIG. 8, the primary-side valve element 7 includes a primary-side cylindrical member 71 (primary-side tubular member), a valve shaft part 72 (shaft member), a fixing ring 73, a rotating ring 74, a disk member 75, an elastic member 76, a fixing clip 77, and a primary-side outer peripheral O-ring 78. The primary-side cylindrical member 71, the valve shaft part 72, the fixing ring 73, the rotating ring 74, the disk member 75, the elastic member 76, and the fixing clip 77 are disposed coaxially with the rotation axis J of the primary-side valve element 7.

As shown in FIG. 8, the primary-side cylindrical member 71 is formed in a cylindrical shape and extends in the direction of the rotation axis J. The primary-side cylindrical member 71 is made from resin. The primary-side cylindrical member 71 includes six hot and cold water inflow openings 711 (inflow openings). The primary-side outer peripheral O-ring 78 is attached to the outer peripheral face of the primary-side cylindrical member 71.

As shown in FIG. 8, six hot and cold water inflow openings 711 (partially not shown) are disposed in a row spaced apart from each other in a circumferential direction of the primary-side cylindrical member 71, and are formed to penetrate in a radial direction of the primary-side cylindrical member 71. Three of the six hot and cold water inflow openings 711 are defined as a set, and two sets are circumferentially disposed apart from each other. The six hot and cold water inflow openings 711 allow cold water introduced into the interior of the housing 20 of the faucet body 2 by the cold water-side crank leg 311 and hot water introduced into the interior of the housing 20 of the faucet body 2 by the hot water-side crank leg 312, to flow into the interior of the primary-side valve element 7.

As shown in FIG. 8, the fixing ring 73 is formed in a substantially annular shape having a thickness in the direction of the rotation axis J of the primary-side cylindrical member 71. The fixing ring 73 is fixed to the primary-side cylindrical member 71 on the front side in the direction of the rotation axis J of the primary-side cylindrical member 71. The fixing ring 73 includes a pair of fixing projecting parts 731 projecting in a radial direction, and a pair of engagement recesses 732 that are recessed rearward in the direction of the rotation axis J inside the pair of fixing projecting parts 731.

With respect to the fixing ring 73, the pair of fixing projecting parts 731 is fitted and fixed in a pair of locking grooves 712 of the primary-side cylindrical member 71 in a state in which the elastic member 76 in a coil shape is pressed against the primary-side cylindrical member 71. The pair of engagement recesses 732 is engaged with a pair of engagement projections 741 (described later) of the rotating ring 74 when the switching handle 4 is positioned at the water stop position by rotation of the rotating ring 74.

As shown in FIG. 8, the rotating ring 74 is formed in a substantially annular shape having a thickness in the direction of the rotation axis J. The rotating ring 74 rotates integrally with the valve shaft part 72 by the engagement of a second engagement projecting part 721b of a shaft part 721 of the valve shaft part 72 with an engagement recess 742 formed at the inner peripheral edge. The rotating ring 74 includes the pair of engagement projections 741 projecting rearward in the axial direction. When the rotating ring 74 rotates, the pair of engagement projections 741 engages with the pair of engagement recesses 732 of the fixing ring 73, whereby a click feeling can be generated when the switching handle 4 moves to the water stop position.

As shown in FIGS. 4, 5, and 8, the valve shaft part 72 includes the shaft part 721, a disk holding part 722 disposed on the rear side of the shaft part 721, and four connecting members 723 connecting the shaft part 721 with the disk holding member.

The shaft part 721 is formed in a rod shape and extends in the direction of the rotation axis J. The shaft part 721 penetrates the primary-side cylindrical member 71, the fixing ring 73, the rotating ring 74, the elastic member 76, and the fixing clip 77 in the direction of the rotation axis J.

As shown in FIG. 8, the shaft part 721 includes a first engagement projecting part 721a and a second engagement projecting part 721b that project in a radial direction, and a clip fixing groove 721c. The first engagement projecting part 721a is formed at the front end of the shaft part 721 and engages with the engagement member 11 (see FIG. 2). The second engagement projecting part 721b is formed behind the first engagement projecting part 721a in the shaft part 721, and engages with the engagement recess 742 of the rotating ring 74.

The disk holding part 722 is formed in an annular shape having a diameter larger than the diameter of the shaft part 721. The disk holding part 722 supports the disk member 75 by holding the disk member 75 at the rear end.

The four connecting members 723 connect the rear end of the shaft part 721 with the inner peripheral edge of the disk holding part 722. The four connecting members 723 circumferentially have a predetermined width, and are circumferentially disposed apart from each other. Each of the four connecting members 723 is formed in a shape in which a cross section cut in the axial direction is bent into a substantially L-shape. A valve shaft part-side inflow opening 724 is formed between adjacent connecting members 723. Four valve shaft part-side inflow openings 724 are circumferentially formed apart from each other. By forming the four valve shaft part-side inflow openings 724, the valve shaft part 72 is configured to allow water that has flowed into the primary-side valve element 7 through the six hot and cold water inflow openings 711 to flow between the disk member 75 and the valve shaft part 72 through the four valve shaft part-side inflow openings 724.

The fixing clip 77 is formed in a substantially C-shape, and is attached to the clip fixing groove 721c on the leading end side of the shaft part 721 of the valve shaft part 72. The fixing clip 77 fixes the fixing ring 73 and the rotating ring 74, which are disposed to penetrate the shaft part 721 of the valve shaft part 72, to the shaft part 721 of the valve shaft part 72 in a state in which the fixing ring 73 and the rotating ring 74 are pressed toward the elastic member 76.

The disk member 75 is attached to the rear face of the disk holding part 722 of the valve shaft part 72 in the direction of the rotation axis J. The disk member 75 is formed in a disk shape. The disk member 75 is made from metal. In some embodiments, the disk member 75 is made from, for example, stainless steel. The material from which the disk member 75 is made is not limited to stainless steel. For example, when the disk member 75 is made from metal, the disk member 75 may be made from titanium, aluminum, or the like. Further, the disk member 75 may be made from ceramic, resin material, or the like instead of metal.

As shown in FIGS. 7 and 8, the disk member 75 includes a disk part 751 and a pair of mounting pieces 753. The pair of mounting pieces 753 is formed on the outer periphery of the disk part 751 so as to project toward the valve shaft part 72 in the axial direction. The pair of mounting pieces 753 is mounted to the disk holding part 722 at the rear end of the disk holding part 722 of the valve shaft part 72 in the direction of the rotation axis J. The disk member 75, in a state of being mounted to the disk holding part 722, is movable toward the secondary-side valve element 8 with respect to the primary-side cylindrical member 71 by water pressure applied to the primary-side valve element 7 through the six hot and cold water inflow openings 711.

As shown in FIGS. 7 and 8, a mounting face 751a of the disk part 751 on the valve shaft part 72 side and a sliding plane 751b (planar part) of the disk part 751 on the opposite side of the valve shaft part 72 are formed in a planar shape. The sliding plane 751b of the disk part 751 on the opposite side of the valve shaft part 72 is a face which slides in a state of being in contact with the packing member 85 of the secondary-side valve element 8 when the secondary-side valve element 8 is connected to the primary-side valve element 7.

As shown in FIG. 9A, a disk opening 752 (primary-side opening) is formed in the disk part 751. The disk opening 752 is formed in a shape in which two triangular openings 752a having a substantially triangular shape with a rounded corner are continuous at a position displaced from the center of the disk part 751 in a radial direction. The two triangular openings 752a are formed symmetrically on one side and the other side in a circumferential direction with a virtual base 752b extending in a radial direction of the disk part 751 as a boundary. The disk opening 752 has vertexes 752c which are disposed on one side and the other side in the circumferential direction with respect to the virtual base 752b. The two triangular openings 752a are formed in a substantially triangular shape in which the opening area gradually increases from the vertex 752c toward the virtual base 752b.

An outer side 752d (outer peripheral edge) of the triangular opening 752a of the disk opening 752 is not formed along a circular shape centered on the rotation axis of the disk member 75. In some embodiments, the outer side 752d (outer peripheral edge) of the triangular opening 752a of the disk opening 752 is not formed along a circular outer peripheral edge 751c of the disk part 751, but is linearly formed. More specifically, the outer side 752d of the triangular opening 752a of the disk opening 752 is linearly formed to intersect at an acute angle with respect to a radial direction of the disk part 751, and the outer peripheral edge 751c of the disk part 751 is formed in a circular shape.

As shown in FIGS. 4 and 5, the secondary-side valve element 8 is connected to the primary-side valve element 7 to be slidable to the sliding plane 751b (planar part) of the disk member 75 of the primary-side valve element 7. As shown in FIGS. 4 to 6, the secondary-side valve element 8 includes a secondary-side cylindrical member 81 and the packing member 85.

As shown in FIG. 6, the secondary-side cylindrical member 81 is formed in a cylindrical shape and extends in the direction of the rotation axis J of the primary-side valve element 7. The secondary-side cylindrical member 81 is made from resin. A secondary-side outer peripheral first O-ring 86 and a secondary-side outer peripheral second O-ring 87 are attached to the outer peripheral face of the secondary-side cylindrical member 81.

As shown in FIGS. 6 and 7, when the primary-side valve element 7 and the secondary-side valve element 8 are connected to each other, the secondary-side cylindrical member 81 is locked to the primary-side cylindrical member 71 of the primary-side valve element 7 by means of two sets of locking structures 61 and 62. The two sets of locking structures 61 and 62 are configured to lock with locking parts axially projecting or being recessed on peripheral faces of the primary-side valve element 7 and the secondary-side valve element 8. In some embodiments, the two sets of locking structures 61 and 62 are disposed at positions spaced apart from each other by 180 degrees in circumferential directions of the primary-side valve element 7 and the secondary-side valve element 8.

As shown in FIG. 6, the locking structure 61 is composed of a locking recess 713 (second locking part) of the primary-side cylindrical member 71 of the primary-side valve element 7 and a locking projection 811 (first locking part) of the secondary-side cylindrical member 81 of the secondary-side valve element 8. As shown in FIGS. 6 and 7, the other locking structure 62 is composed of a locking recess 714 (second locking part) of the primary-side cylindrical member 71 of the primary-side valve element 7 and a locking projection 812 (first locking part) of the secondary-side cylindrical member 81 of the secondary-side valve element 8.

In the two sets of locking structures 61 and 62, the locking recesses 713 and 714 are disposed at positions spaced apart from each other circumferentially by 180 degrees on the peripheral edge of the primary-side cylindrical member 71. The locking recesses 713 and 714 are respectively recessed from the rear end to the front side in the direction of the rotation axis J of the primary-side cylindrical member 71 on a peripheral face of the primary-side cylindrical member 71. The locking recesses 713 and 714 have a circumferentially predetermined width, and rectangular recesses 713a and 714a that are recessed from the rear end in the direction of the rotation axis J in a rectangular shape and trapezoidal recesses 713b and 714b that are recessed from the rectangular recesses 713a and 714a to the front side in the direction of the rotation axis J are successively formed. The trapezoidal recesses 713b and 714b are formed in a trapezoidal shape with a long base on the side of the rectangular recesses 713a and 714a, and triangular depressions 713c and 714c that are recessed from the rectangular recesses 713a and 714a on both sides in a circumferential direction in a triangular shape are formed on the side of the rectangular recesses 713a and 714a of the trapezoidal recesses 713b and 714b. The rectangular recesses 713a and 714a and the trapezoidal recesses 713b and 714b extend and are recessed on the peripheral face of the primary-side cylindrical member 71 in the direction of the rotation axis J. The triangular depressions 713c and 714c are recessed in the peripheral face of the primary-side cylindrical member 71 from the rectangular recesses 713a and 714a and the trapezoidal recesses 713b and 714b in a direction intersecting the direction of the rotation axis J.

As shown in FIG. 6, in the two sets of locking structures 61 and 62, the locking projections 811 and 812 are disposed at positions spaced apart from each other circumferentially by 180 degrees on the peripheral edge of the secondary-side cylindrical member 81. The locking projections 811 and 812 respectively extend forward from the front end of the peripheral face of the secondary-side cylindrical member 81 in the direction of the rotation axis J of the primary-side cylindrical member 71. The locking projections 811 and 812 have a circumferentially predetermined width, and rectangular extensions 811a and 812a that extend forward from the front end in the direction of the rotation axis J and trapezoidal extensions 811b and 812b that extend forward from the rectangular extensions 811a and 812a in the direction of the rotation axis J are successively formed. The trapezoidal extensions 811b and 812b are formed in a trapezoidal shape with a long base on the side of the rectangular extensions 811a and 812a, and triangular protrusions 811c and 812c are formed so as to protrude past the rectangular extensions 811a and 812a on both sides in a circumferential direction, on the side of the rectangular extensions 811a and 812a of the trapezoidal extensions 811b and 812b. The rectangular extensions 811a and 812a and the trapezoidal extensions 811b and 812b extend in the peripheral face of the secondary-side cylindrical member 81 in the direction of the rotation axis J. The triangular protrusions 811c and 812c extend in the peripheral face of the secondary-side cylindrical member 81 from the rectangular extensions 811a and 812a and the trapezoidal extensions 811b and 812b in a direction intersecting the direction of the rotation axis J.

In the locking structures 61 and 62 configured as described above, the primary-side valve element 7 and the secondary-side valve element 8 are locked in the following manner: the locking projection 811 and 812 of the secondary-side cylindrical member 81 are inserted in the locking recesses 713 and 714 of the primary-side cylindrical member 71, and the locking projections 811 and 812 of the secondary-side cylindrical member 81 are locked by the locking recesses 713 and 714 of the primary-side cylindrical member 71 in a state in which the triangular protrusions 811c and 812c are caught by the triangular depressions 713c and 714

In the two sets of locking structures 61 and 62, the locking recesses 713 and 714 respectively constituting the locking structures 61 and 62 have different shapes, and the locking projections 811 and 812 respectively constituting the locking structures 61 and 62 have different shapes.

More specifically, as shown in FIG. 6, in the two sets of locking structures 61 and 62, an incorrect assembling prevention projection 713d (projection) is formed in the locking recess 713 of the locking recesses 713 and 714 of the primary-side valve element 7. The incorrect assembling prevention projection 713d projects rearward from the front end side of the trapezoidal recess 713b in the direction of the rotation axis J. No incorrect assembling prevention projection is formed in the other locking recess 714.

As shown in FIG. 6, in the two sets of locking structures 61 and 62, an incorrect assembling prevention recess 811d is formed in the locking projection 811 of the locking projections 811 and 812 of the secondary-side valve element 8. When assembling the primary-side valve element 7 and the secondary-side valve element 8, the incorrect assembling prevention recess 811d is fitted into the incorrect assembling prevention projection 713d of the locking recess 713 of the primary-side valve element 7. The incorrect assembling prevention recess 811d is recessed rearward from the front end side of the trapezoidal extension 811b in the direction of the rotation axis J. No incorrect assembling prevention recess is formed in the other locking projection 812.

As a result, when assembling the primary-side valve element 7 and the secondary-side valve element 8, since the incorrect assembling prevention recess 811d of the locking projection 811 of the secondary-side valve element 8 can be assembled only to the incorrect assembling prevention projection 713d of the locking recess 713 of the primary-side valve element 7, incorrect assembling of the primary-side valve element 7 and the secondary-side valve element 8 can be prevented.

As shown in FIGS. 4 to 6 and 9A, the secondary-side cylindrical member 81 includes the shower-side opening 821 (water passage hole), a shower-side water passage F1 (water passage) extending from the shower-side opening 821, the faucet-side opening 822 (water passage hole), and a faucet-side water passage F2 (water passage) extending from the faucet-side opening 822. As shown in FIG. 9B, the secondary-side cylindrical member 81 includes a packing arrangement groove 841, a grease reservoir 842, and a grease supply groove 843.

When the primary-side valve element 7 and the secondary-side valve element 8 are connected to each other, water from the primary-side valve element 7 can flow through the shower-side opening 821 and the faucet-side opening 822. As shown in FIG. 6 and FIG. 9B, the shower-side opening 821 and the faucet-side opening 822 are formed to be a sector-shaped opening inside two arc parts among three arc parts obtained by dividing the center angle into three in the part of the secondary-side cylindrical member 81 facing the sliding plane 751b of the disk member 75. The shower-side opening 821 and the faucet-side opening 822, when the disk member 75 is rotated to be overlapped with the opening, are formed to have substantially the same size and substantially the same shape as the disk opening 752 of the disk member 75. However, the outer peripheral edges of the shower-side opening 821 and the faucet-side opening 822 are formed in a circular shape, and the shower-side opening 821 and the faucet-side opening 822 have different shapes from that of the disk opening 752 of the disk member 75 in that the outer peripheral edge of the disk opening 752 of the disk member 75 is linearly formed.

As shown in FIG. 6, the shower-side water passage F1 is connected to the shower-side opening 821. As shown in FIGS. 5 and 6, the shower-side water passage F1 is formed to pass through the secondary-side cylindrical member 81 in a direction parallel to the axial direction. The shower-side water passage F1 is a passage for passing hot and cold water toward the faucet-side water discharging part 331 (see FIG. 1).

As shown in FIG. 6, the faucet-side water passage F2 is connected to the faucet-side opening 822. As shown in FIGS. 4 and 6, the faucet-side water passage F2 extends partway in the axial direction of the secondary-side cylindrical member 81, and is formed to penetrate in a radial direction from the partway in the axial direction of the secondary-side cylindrical member 81. The faucet-side water passage F2 is a passage through which hot and cold water flows toward the faucet-side water discharging part 331 (see FIG. 1).

As shown in FIG. 6 and FIG. 9B, the packing arrangement groove 841 is formed around the shower-side opening 821 and the faucet-side opening 822. The packing arrangement groove 841 is formed in the part of the secondary-side cylindrical member 81 facing the disk member 75 to surround the entire periphery of the shower-side opening 821 and the faucet-side opening 822. As shown in FIG. 9B, the packing arrangement groove 841 is formed in a state in which two sector-shaped annular grooves 841a whose outer shape is a sector shape are arranged in a circumferential direction and connected to each other in two sector-shaped parts among three sector-shaped parts formed by dividing the center angle into three. The two sector-shaped annular grooves 841a of the packing arrangement groove 841 are circumferentially adjacently connected to each other with a groove extending in a radial direction of the secondary-side cylindrical member 81 as a common groove in the connection part. The packing member 85 is arranged in the packing arrangement groove 841.

As shown in FIG. 6 and FIG. 9B, the packing member 85 is arranged along the packing arrangement groove 841 so as to be arranged around the shower-side opening 821 and the faucet-side opening 822. The packing member 85 is disposed to be in contact with the sliding plane 751b (planar part) of the disk member 75 of the primary-side valve element 7. The packing member 85 is formed in a state in which two sector-shaped annular parts 851 having a sector shape are arranged in the circumferential direction and connected to each other. The two sector-shaped annular parts 851 of the packing member 85 are circumferentially adjacently connected to each other with the part extending in a radial direction of the secondary-side cylindrical member 81 as a common groove in the connection part.

The grease reservoir 842 is filled with grease. As shown in FIG. 6 and FIG. 9B, when the primary-side valve element 7 and the secondary-side valve element 8 are connected to each other, the grease reservoir 842 is formed to be recessed in a part of the secondary-side cylindrical member 81 facing the disk member 75. The grease reservoir 842 is formed on an obliquely upper side in the secondary-side cylindrical member 81. The grease reservoir 842 is formed to be recessed in an arc shape in a part other than parts in which the shower-side opening 821 and the faucet-side opening 822 are provided, among three arc parts obtained by dividing the center angle into three in the part of the secondary-side cylindrical member 81 facing the disk member 75. The grease reservoir 842 is filled with viscous grease. When the disk type valve device 6 is mounted to the faucet apparatus 1, the grease reservoir 842 is disposed obliquely above the grease supply groove 843 in the part of the secondary-side cylindrical member 81 facing the disk member 75.

The grease supply groove 843 connects the grease reservoir 842 and the packing arrangement groove 841. The grease supply groove 843 extends obliquely downward from the grease reservoir 842 in the vicinity of the center of the part of the secondary-side cylindrical member 81 facing the disk member 75. The grease filled in the grease reservoir 842 is supplied to the packing arrangement groove 841 through the grease supply groove 843.

In the disk type valve device 6 configured as described above, the primary-side valve element 7 is rotated by rotating the switching handle 4, and the disk member 75 attached to the primary-side valve element 7 is rotated. Since the disk member 75 is fixed to the primary-side valve element 7, the primary-side valve element 7, which is a movable valve, rotates so that the disk member 75 rotates with respect to the secondary-side valve element 8, which is a fixed valve. As shown in FIGS. 10A-10C, the disk member 75 is configured to be rotatably movable to a water stop position (see FIG. 10A), in which water stops in a state where the disk opening 752 overlaps with the grease reservoir 842; a shower-side position (see FIG. 10B), in which the disk opening 752 overlaps with the shower-side opening 821 of the secondary-side valve element 8 to communicates with the shower-side opening 821; and a faucet-side position (see FIG. 10C), in which the disk opening 752 overlaps with the faucet-side opening 822 of the secondary-side valve element 8 to communicates with the faucet-side opening 822.

Further, by adjusting the rotation angle of the disk member 75 at the shower-side position (see FIG. 10B), the degree of overlap between the disk opening 752 and the shower-side opening 821 is adjusted so as to adjust the flow rate of water discharged from the shower-side water discharging part 332. In addition, by adjusting the rotation angle of the disk member 75 at the faucet-side position (see FIG. 10C), the degree of overlap between the disk opening 752 and the faucet-side opening 822 is adjusted so as to adjust the flow rate of water discharged from the faucet-side water discharging part 331.

As described above, when the disk type valve device 6 is positioned at the water stop position (see FIG. 10A) by rotation of the primary-side valve element 7, water is stopped by the sliding plane 751b of the disk member 75 and the packing member 85 disposed around the shower-side opening 821 and the faucet-side opening 822. In this state, the disk member 75, while being attached to the disk holding part 722, moves toward the secondary-side valve element 8 with respect to the primary-side cylindrical member 71 by water pressure applied to the primary-side valve element 7 through the six hot and cold water inflow openings 711. As a result, water can be stopped by contacting the packing member 85 with the sliding plane 751b of the disk member 75 of the primary-side valve element 7, and the primary-side valve element 7 and the secondary-side valve element 8 do not need to be formed long in the axial direction, and the length in the length direction of the disk type valve device 6 can be formed compactly.

Herein, as shown in FIG. 11, when temporary strong water pressure P1 (water hammer) is applied to the primary-side valve element 7, weak water pressure P2 is applied after the temporary strong water pressure P1 (water hammer) is applied to the primary-side valve element 7, and the disk member 75 moves to a side away from the disk member 75 by the urging force of the elastic member 76. As a result, the packing member 85 and the disk member 75 are momentarily separated from each other, whereby the gap S is formed between the disk member 75 and the packing member 85. Then, since water escapes from the gap S, it is possible to lower the high water pressure and to prevent an adverse effect due to the high water pressure. Consequently, the durability of the disk type valve device 6 can be improved.

In some embodiments, the primary-side valve element 7 includes a disk-shaped disk member 75 including a sliding plane 751b, and the disk member 75 is made from metal. Therefore, for example, even when dust enters, it is possible to reduce the formation of scratches on the disk member 75 due to dust or the like, as compared with a case where the disk member 75 is made from a resin material.

When the disk member 75 rotates, grease stored in the grease reservoir 842 is pushed out to the packing arrangement groove 841 through the grease supply groove 843 by the disk member 75. As a result, even if the amount of grease in the packing arrangement groove 841 is reduced, grease is continuously supplied to the packing arrangement groove 841 via the grease supply groove 843. As a result, the sliding resistance between the packing member 85 arranged in the packing arrangement groove 841 and the sliding plane 751b of the disk member 75 of the primary-side valve element 7 can be continuously reduced.

As shown in FIG. 10A, when the disk type valve device 6 is in the water stop state, in a state where the grease reservoir 842 faces the disk opening 752 of the disk member 75, the packing member 85 disposed around the shower-side opening 821 and the faucet-side opening 822 contacts the disk member 75, thereby closing the shower-side opening 821 and the faucet-side opening 822 to stop water. As a result, when the disk type valve device 6 is in the water stop state, the shower-side opening 821 and the faucet-side opening 822 are closed, so that the grease filled in the grease reservoir 842 is prevented from flowing out through the shower-side opening 821 and the faucet-side opening 822.

The disk opening 752 of the disk part 751 of the disk member 75 is formed in a substantially triangular shape in which the opening area gradually increases from the vertex 752c toward the virtual base 752b. Therefore, the disk member 75 is rotated to gradually open the area in which hot and cold water passes through the disk opening 752. As a result, a water hammer phenomenon can be reduced because hot and cold water does not rapidly pass through the shower-side opening 821 and the faucet-side opening 822.

The outer side 752d of the disk opening 752 of the disk-shaped disk member 75 is not formed along the outer peripheral edge 751c of the disk member 75. Therefore, when the disk part 751 of the disk member 75 rotates, the outer side 752d of the disk opening 752 moves not continuing to contact the same position of the packing member 85 but contacting radially different positions. As a result, the radial position of the outer side 752d of the disk opening 752 is moved without the outer side 752d continuing to contact the same position of the packing member 85. Therefore, damage to the packing member 85 can be reduced.

As explained above, in some embodiments, the following effects are exerted. The disk type valve device 6 of some embodiments includes the primary-side valve element 7 including the sliding plane 751b and the secondary-side valve element 8 that is connected to the primary-side valve element 7 to be slidable to the sliding plane 751b of the primary-side valve element 7. The water discharge state can be switched by sliding the primary-side valve element 7 or the secondary-side valve element 8. The secondary-side valve element 8 includes the packing member 85 that contacts the sliding plane 751b of the primary-side valve element 7. Therefore, water can be stopped by contacting the packing member 85 with the sliding plane 751b of the disk member 75 of the primary-side valve element 7, and thus, the primary-side valve element 7 and the secondary-side valve element 8 do not need to be formed long in the axial direction, and the disk type valve device 6 can be formed compactly.

In some embodiments, the primary-side valve element 7 includes the disk member 75 including the sliding plane 751b, and the disk member 75 is made from metal. Therefore, for example, even when dust enters, it is possible to reduce the formation of scratches on the disk member 75 due to dust or the like, as compared with a case where the disk member 75 is made from a resin material.

Further, in some embodiments, the primary-side valve element 7 allows water to flow between the disk member 75 and the valve shaft part 72. Therefore, by allowing water to flow between the disk member 75 and the valve shaft part 72 in the primary-side valve element 7, hot and cold water can be made to flow from the primary-side valve element 7 toward the secondary-side valve element 8 with a simple configuration.

In some embodiments, the primary-side valve element 7 is a movable valve that can be rotated at the time of operation. By configuring the primary-side valve element 7 to be a movable valve, it is possible to move the primary-side valve element 7 at a position where a large space is secured, so that operability can be improved, as compared with configuring the secondary-side valve element 8 to be a movable valve. In the secondary-side valve element 8, the secondary-side outer peripheral first O-ring 86 and the secondary-side outer peripheral second O-ring 87 are attached to the outer peripheral face of the secondary-side cylindrical member 81. Therefore, if the secondary-side valve element 8 is configured to be a movable valve, the sliding resistance increases. In contrast, configuring the primary-side valve element 7 to be a movable valve can reduce the sliding resistance more than configuring the secondary-side valve element 8 to be a movable valve.

In some embodiments, the primary-side valve element 7 includes the disk-shaped disk member 75 including the disk opening 752, and the outer sides 752d of the disk opening 752 are not formed along the outer peripheral edge 751c of the disk member 75. Therefore, when the disk part 751 of the disk member 75 rotates, the outer side 752d of the disk opening 752 moves not continuing to contact the same position but contacting radially different positions. As a result, the radial position of the outer side 752d of the disk opening 752 is moved without the outer side 752d continuing to contact the same position of the packing member 85. Therefore, damage to the packing member 85 can be reduced.

In some embodiments, the disk member 75 is movable toward the secondary-side valve element 8 with respect to the primary-side cylindrical member 71 by water pressure applied to the primary-side valve element 7. As a result, when the water pressure is high, the disk member 75 is pushed and moved toward the packing member 85 of the secondary-side valve element 8, and the water stop state with the packing member 85 can be strengthened. If the disk member 75 is constantly pushed strongly, the sliding property deteriorates. However, by configuring the disk member 75 in this manner, if the water pressure is low, the force with which the disk member 75 is pushed toward the packing member 85 of the secondary-side valve element 8 can be reduced. Therefore, since the disk type valve device 6 can be easily operated, the operability can be improved.

Further, in some embodiments, the gap S is formed between the disk member 75 and the packing member 85 by applying strong water pressure P1 and subsequently applying weak water pressure P2 to the primary-side valve element 7. Then, since water escapes from the gap S, it is possible to lower high water pressure and to prevent an adverse effect due to high water pressure. As a result, the durability of the disk type valve device 6 can be improved.

The present invention is not limited to the embodiments described above and can be modified as appropriate. For example, in some embodiments, the disk type valve device 6 is configured such that the primary-side valve element 7 is a movable valve, and the water flow state and the water stop state can be switched by the rotation of the primary-side valve element 7; however, the present invention is not limited to this configuration. The secondary-side valve element 8 may be configured as a movable valve such that the water flow state and the water stop state can be switched by the rotation of the secondary-side valve element 8.

In some embodiments, the disk member 75 is formed in a disk shape, but the present invention is not limited thereto. For example, the outer shape of the disk member may be formed not in a circle shape but in a polygon shape, or the disk member may be composed of a member having a thickness greater than that of disk (plate).

1. A valve device, comprising:
a primary-side valve element comprising a planar part; and
a secondary-side valve element comprising a packing member that contacts the planar part of the primary-side valve element, the secondary-side valve element connected to the primary-side valve element such that the secondary-side valve is slidable to the planar part of the primary-side valve element,
wherein a water discharge state is configured to be switched by sliding one of the primary-side valve element or the secondary-side valve element.

2. The valve device of claim 1, wherein the primary-side valve element comprises a disk member comprising the planar part, and
the disk member comprises a metal.

3. The valve device of claim 1, wherein the primary-side valve element comprises a disk member comprising the planar part and a shaft member supporting the disk member, wherein the primary-side valve element is configured to allow water to flow between the disk member and the shaft member.

4. The valve device of claim 1, wherein the primary-side valve element comprises a movable valve that can be rotated at a time of operation.

5. The valve device of claim 1, wherein the primary-side valve element comprises a disk member comprising a primary-side opening, and
an outer peripheral edge of the primary-side opening is not formed along a circular shape centered on a rotation axis of the disk member.

6. The valve device of claim 1, wherein the primary-side valve element comprises a primary-side tubular member and a disk member including the planar part, and
the disk member is movable toward the secondary-side valve element with respect to the primary-side tubular member by water pressure applied to the primary-side valve element.

7. The valve device of claim 6, wherein a gap is formed between the disk member and the packing member by applying strong water pressure and subsequently applying weak water pressure to the primary-side valve element.
